(19) United States
(12) Patent Application Publication
(10) Pub. No.: US 2003/0231206 A1
(43) Pub. Date: Dec. 18, 2003

(54) Embedded user interface in a communication device

(76) Inventor: Jennifer Phoebe Armstrong, Stone Mountain, GA (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(21) Appl. No.: 10/423,335

(22) Filed: Apr. 24, 2003

Related U.S. Application Data
(60) Provisional application No. 60/375,302, filed on Apr. 24, 2002.

(51) Int. Cl. G09G 5/00

(52) U.S. Cl. 345/744

(57) ABSTRACT

An embedded user interface within a communication device communicates with a user's computer for configuring Internet access, troubleshooting Internet service, and controlling user access to the Internet. Upon receiving a request to provide content from the Internet, the communication device determines if Internet access is available. If the communication device is not connected or the Internet connection is already in use, the device returns a web page generated locally within the communication device. Otherwise, the request is delivered via a broadband connection.

### CROSS REFERENCE TO RELATED APPLICATIONS

This patent application claims priority under Title 35, United States Code Section 119(e) to U.S. Provisional Patent Application No. 60/375,302 entitled “Embedded User Interface and Methods for Communication Device” filed on Apr. 24, 2002, which is incorporated in its entirety and made a part hereof.

### FIELD OF THE INVENTION

The present invention relates generally to accessing communication systems and networks. More particularly, the present invention relates to a user interface embedded in a communication device for configuring, troubleshooting, and controlling user access to communication systems and networks.

### BACKGROUND OF THE INVENTION

The broadband industry enjoys a steady growth in demand for high-speed Internet access. However, while consumers of Internet services clamor for greater access speeds, many are not willing or able to incur significant installation and configuration complexity in order to achieve faster Internet access. Additionally, many subscribers are aggravated when their connection is not operable and frustrated when they do not know how to troubleshoot the connection. Consequently, in order to achieve rapid acceptance by consumers, broadband services must to easy to install and troubleshoot.

Currently, broadband networking configuration and setup solutions involve substantial user configuration of the network endpoint, usually a modem (derived from “modulation/demodulation”) and may require the user to install network interface devices. Typically, a series of users guides instruct users on how to accomplish the setup and troubleshoot problems with Internet access. However, many people attempt installation without using the user guide, which may create additional problems. Further, in many instances, users cannot locate their instruction manuals when an access problems occurs.

Nevertheless, connectivity to a high speed network is typically obtained by connecting a physical layer device, such as network interface card, to a high speed communication access device generally referred to as a “modem.” These local communication access devices connect the user to a service network network. The service network then connects to the Internet.

For example, existing twisted wire pair phone lines can be used to provide high-speed connections to the Internet by using a variety of Digital Subscriber Line (DSL) technologies. The term xDSL is used to refer to all varieties of DSL, such as, but not limited to, Asymmetric Digital Subscriber Line (ADSL) (including G.Lite and Rate Adaptive Digital Subscriber Line (RADSL)), High-bit-rate Digital Subscriber Line (HDSL), Symmetric Digital Subscriber Line (SDSL), Single-pair High-speed Digital Subscriber Line (SHDSL), Very High Data Digital Subscriber Line (VDSL) (including Very-high-rate Asymmetric Digital Subscriber Line (VDSL) and Broadband Digital Subscriber Line (BDSL)), and Integrated Services Digital Network Digital Subscriber Line (IDSL). These xDSL technologies utilize the upper frequency of the twisted wire pair to transmit data. A high speed xDSL modem communicates over the existing twisted pair infrastructure to provide high speed Internet access. Hence, if the modem is not configured or cannot otherwise connect to the Internet, no Internet traffic will flow on this xDSL network.

In addition, Internet service providers (IPSs) may desire to control user access to the Internet. For example, an ISP may want to allow only one user to access the Internet from a giving location unless additional fees are paid. In addition, some current systems require a user to consent to payment of a fee in order to gain access to the Internet. For example, some hotel systems require a user to explicitly consent to a fee charged by the hotel in order to grant Internet access.

One method used for obtaining this authorization is by intercepting an initial request by the user to access an Internet server and redirecting the request to a network service web server. The network web server returns a document providing the host IP address of a network web server in place of the requested server's IP address. As a result, the network web server establishes an IP session with the requesting computer rather than the requested Internet provider. During this IP session, the user is requested to consent to pay the hotel fee before Internet access is allowed. The success of this process presupposes the proper function of the network service. Redirecting a request and instead initiating an IP session associated with a network host IP address (referred to as a “hURL) in place of the IP address of the requested Uniform Resource Locator (URL) is commonly referred to as “hURL” or “hURLing.”

The initial configuration, any subsequent reconfigurations, and troubleshooting can be complicated and time consuming process to access a high speed network. An easy, effective solution is needed which will guide the user through the initialization and any troubleshooting processes. Not only should the system be easy to use, the system should not be able to be bypassed, which may lead to additional problems. Furthermore, the system should have the option to control user access to the data network. Consequently, an improved system is needed for configuration, troubleshooting, and controlling access to data networks.

### SUMMARY OF THE INVENTION

An embedded user interface within a communication device can facilitate configuring, troubleshooting, and controlling access to a communication network. Upon receiving a request to provide content from a communication network, the communication device determines if the communication network access is available. If the communication device is not configured, not connected, or the connection is already in use, the communication device, according to various aspects of the invention, returns a web page generated locally within the communication device. Otherwise, the request is delivered via a broadband connection to the Internet service provider.

In one aspect of the invention, a hardware communication device provides data communications between a user computer and a communication network. However, no aspects of the invention requires successful connectivity to any outside resource, network, or other previously existing entity to perform this or any aspect of the invention. If the communication device is not configured, the hardware communication device intercepts an initial network request provided by a user's computer. The hardware communication device returns an embedded HTML document associated with IP address of the communication device (the host IP address) rather than the requested document from the requested wide area network address. The returned embedded user interface prompts the user to input the user configuration information and stores the supplied configuration information in memory associated with the onboard processor.

In another aspect of the invention, a hardware communication device provides data communications between a user computer and a communication network. If the communication device is not connected to a wide area network, when the hardware communication device receives any network requests provided by a user's computer, the hardware communication device returns an embedded HTML document associated with IP address of the communication device (the host IP address) rather than the requested document from the requested IP address to the additional computer. The returned embedded user interface displays troubling shooting information directed to establishing access.

In yet another aspect of the invention, a hardware communication device provides data communications between a user computer and a communication network. If the hardware communication device transeives wide area network requests for a user's computer, it can determine if a second or any additional computer is requesting access to a wide area network. If an additional computer is requesting access, the hardware communication device returns an embedded HTML document associated with IP address of the communication device (the host IP address) rather than the requested document from the requested IP address. The returned embedded user interface requests information to authenticate access privileges to the wide area network. Upon receipt of the authentication information, the processor determines whether to control or limit the access for any computer that has requested access to the wide area network.

### BRIEF DESCRIPTION OF THE DRAWINGS

Benefits and further features of the present invention will be apparent from a detailed description of preferred embodiment thereof taken in conjunction with the following drawings, wherein like elements are referred to with like reference numbers, and wherein:

FIG. 1 is a functional block diagram illustrating the operation of a communication device with an embedded user interface in accordance with a preferred embodiment of the present invention.

FIG.2 is a functional block diagram illustrating the operation of an ADSL modem with an embedded user interface in accordance with an exemplary embodiment of the present invention.

FIG. 3 is a flow chart of an embedded UI modem connectivity sequence of an exemplary embodiment of the present invention.

FIG. 4 is a flow chart of an embedded UI modem access control of a preferred embodiment of the present invention.

FIG. 5 is an exemplary screen shot of a Modem Main page.

FIG. 6 is an exemplary screen shot of a Setup page.

FIG. 7 is an exemplary screen shot of a Modem Diagnostic Test page.

FIG. 8 is an exemplary Connection-In-Use page.

FIG. 9. is a block diagram of an exemplary ADSL modem.

### DETAILED DESCRIPTION OF EMBODIMENTS

If the communication device is not configured, not connected, or the Internet connection is already in use, the device returns a web page generated locally within the communication device. The present invention provides an embedded user interface within a communication device for configuring access, troubleshooting, and controlling user access to the Internet. Upon receiving a request to provide content from the Internet, the communication device determines if Internet access is available. Otherwise, the request is delivered via a broadband connection to the Internet service provider.

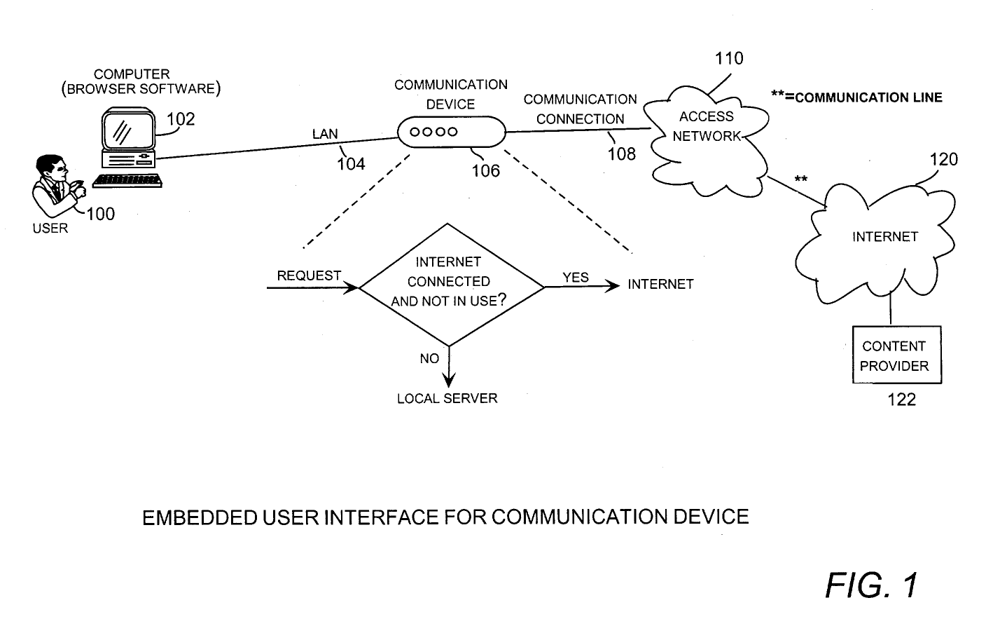

Turning now to FIG. 1, illustrated is the operation of a communication device 106 in accordance with an embodiment of the present invention. The communication device 106 is accessed by a computer 102 using a commercial browser such as INTERNET EXPLORER by Microsoft Corporation to request a connection to the Internet 120. The communication device 106 interfaces with the computer 102 over a local area network (LAN) 104. The communication device 106 then communicates over a broadband connection 108 to the access network 110.

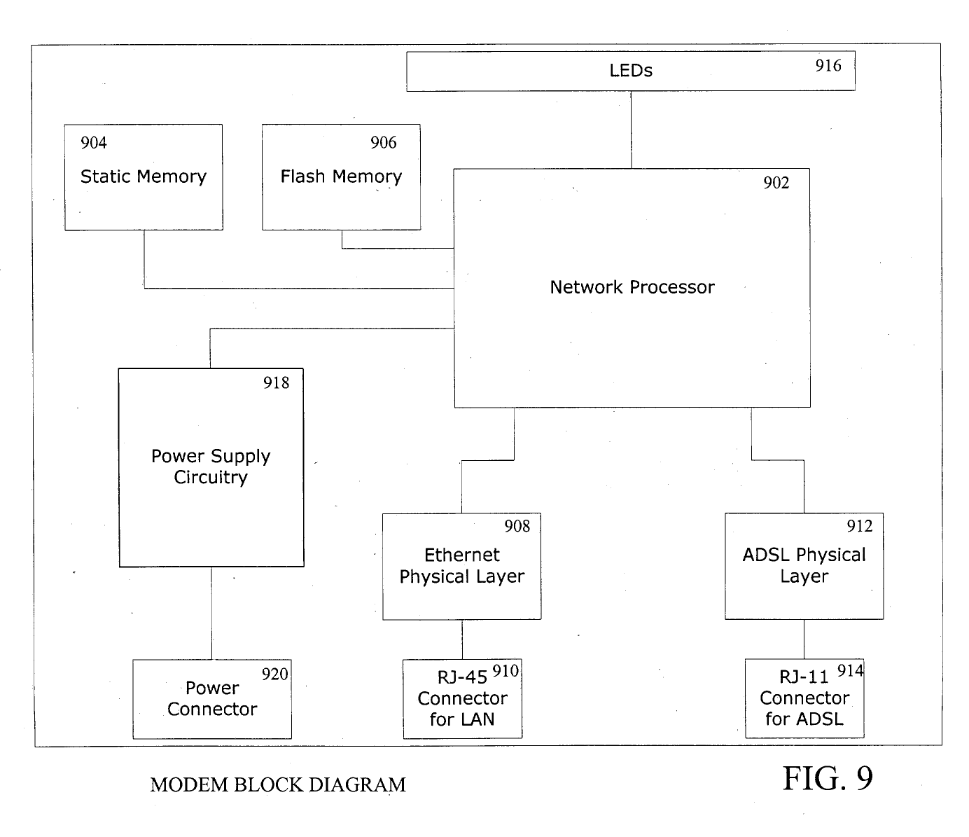

Upon receiving a request to provide content from a content provider 122, the device determines if an Internet connection has been established. If an Internet connection cannot be established, the communication device 106 redirects the user 100 to an internal web server application stored in static memory 901 shown in reference to FIG. 9. The local web server within the communication device 106 force returns a web page providing the host URL (hURL) rather than the requested URL. The hURL web page informs the user 100 that the Internet connection is not currently available. If the device is not configured, a hURL setup page is returned to the user computer 102 for display to the user 100. If the device is not connected, a hURL diagnostic page is returned to the user computer 102 for display to the user 100.

Optionally, according to another aspect of the invention, if the connection is currently in use by another user, a hURL in-use page is returned to the user computer 102 for display to the user 100. The in-use feature can be used to provide user access control for any reason, such as to create an additional income stream for granting multiple user access. If the request is not redirected to the local web server onboard the communication device 106, the request is transmitted via the broadband connection 108 to the access network 110.

Consequently, the communication device 106 functions as a typical modem but has built in functionality to serve as a local web server. The physical layout of the communication device 106 that enables the device 106 to function as a web server is described in reference to FIG. 9. The communication device 106 redirects IP requests to the local web server when it cannot establish IP connectivity or if more than one user is requesting access. As a result, the embedded user interface within the communication device can establish an IP session with the user computer 102. This IP session is now performed between the user computer 102 and the communication device 106 using the hURL of the communication device. This IP session can exist whether or not the communication device 106 can communicate with the access network 110 or any other network device.

If the initial request is an HTTP request, the user's browser will display a returned host URL (hURL) web page generated by a local web server onboard the communication device 106. Software on the end user's machine, not applicable to this invention, can monitor a LAN connection on predetermined port(s) to alert the user of hURL'd traffic that the user may not see if they do not have a web browser opened.

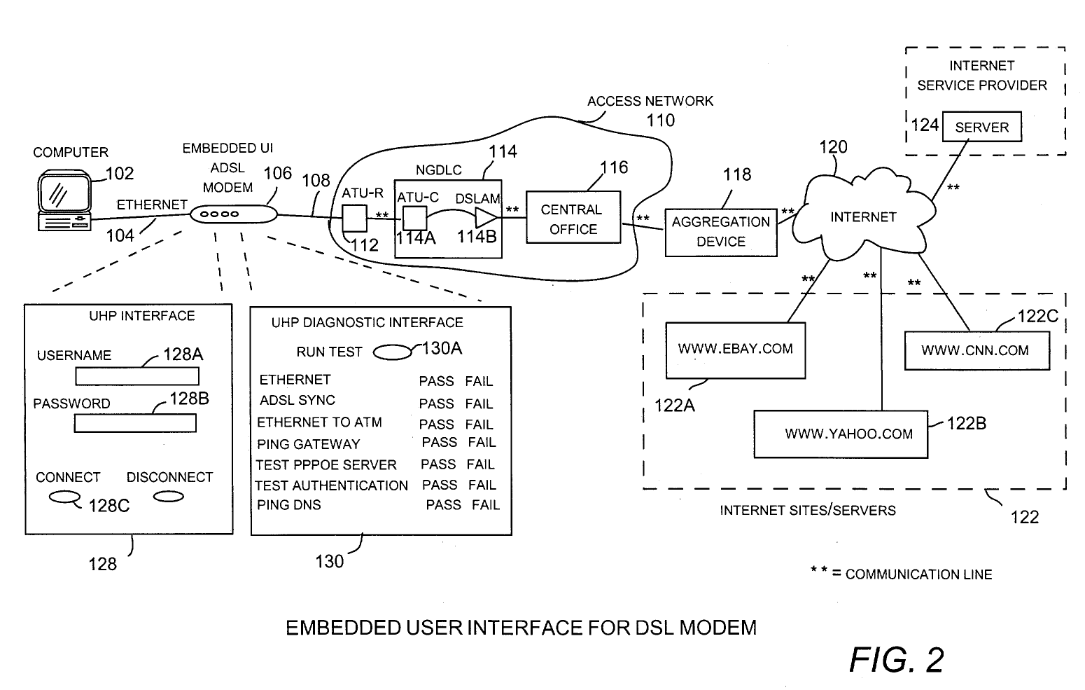

FIG. 2 illustrates the operation of an Asymmetrical Digital Subscriber Line (ADSL) modem with an embedded user interface (UI) for providing broadband network access to a residence in accordance with an exemplary embodiment of the present invention. Although the embedded user interface for a communication device is disclosed in reference to the following embodiments, for example, an asynchronous digital subscriber line (ADSL), those skilled in the art will appreciate that invention can be utilized with other technologies such as but not limited to dial-up connections, xDSL modems, cable modems, satellite modems, WiFi nodes, other local communication devices that connect to an access network, and the like.

ADSL is a well-known, advanced, high-bandwith local loop technology designed to extend the life of existing unshielded twisted pair loops for the transmission of broadband signals. Numerous variations of the presented network for providing broadband services can be utilized as recognized by those skilled in art.

In an embodiment, the embedded UI ADSL modem 106 interfaces with a user's computer 102 using TCP/IP (Transmission Control Protocol/Internet Protocol), a LAN-based protocol over the Ethernet for the LAN 104. The computer 102 is operational to run an operating system capable of displaying graphics such as WINDOWS, LINUX, UNIX and the like. The computer's operating system includes a TCP/IP stack that handles all incoming and outgoing traffic over the LAN 104. The ASDL modem 106 is accessed by a computer 102 using browser software such as INTERNET EXPLORER by Microsoft Corporation.

A DHCP (Dynamic Host Control Protocol) server on the modem configures the local machines on the local network in the same IP range and the same subnet. Those skilled in the art will recognize DHCP is a protocol for assigning dynamic IP address to devices on a network

The ADSL modem 106 receives IP packets encapsulated in Ethernet frames from the user's computer 102. The ISP server 124 is accessed using Point-to-Point Protocol over Ethernet (PPPoE). After receiving the Ethernet frames, the ADSL modem 106 encapsulates the IP packets in PPPoE frames to transmit to the ISP 124. A method for transmitting PPPoE is described in detail in reference to RFC 2516. The Requests for Comments (RFC) document series is a set of technical and organizational notes about the Internet

ADSL is provisioned over unshielded twisted pair (UTP) local loop facilities present in most locations. An ADSL Transmission Unit—Remote (ATU-R) 112 is located on the customer's premises. A matching ADSL Transmission Unit—Central (ATU-C) 114A exists in combination with ATU-R 112 to support a high data rate over UTP copper cable loops. Illustrated is a next generation digital local carrier (ngDLC) 114 with a built in DSLAM 114B. The split off data channels are run through a DSL Access Multiplexer (DSLAM) 114B. The DSLAM 114B is a packet multiplexer that serves to multiplex data packets from multiple customers in order to transmit them over high speed ATM network administered by the local exchange carrier. The ATM is a known network technology that allows cells, which are fixed size data packets, to travel specific channels. ATM circuit values include virtual path identifiers (VPI), virtual channel identifiers (VCI), and ATM encapsulation types. The VPI is a field in the ATM cell header that indicates the end to end routing information of the cell. The VCI is a field in an ATM cell header that identifies the channel inside the virtual path over which the cell is to travel. ATM encapsulation type refers to the method used to preserve or encapsulate other network protocls. A Central Office switch 116 presents the data to the Public Data Network. An aggregation device 120 such as a SMS™ 1800 provided by Redback Networks, Inc aggregates connections from the DSLAMs and other broadband access systems to present to the Internet 120. The aggregation device 120 terminates incoming Virtual Cicuit (VC) from DSL subscribers and hands off the PPP sessions to the ISP 124.

As a result, the ADSL modem 106 deliver PPP over ATM over ADSL across the local loop 114 to a carrier central office 116, then across a regional data network 120 to the ISP point of presence 124. However, using PPP over Ethernet allows deployment of industry standard Ethernet network interface cards (NICs) and Ethernet drivers to connect a computer 102 to the ADSL modem 104. The user 100 deploys the ADSL modem 104 pre-configured with a private circuit or the modem can randomly attempt to try all common broadband VPI and VCI values. In the preferred embodiment, the PPPoE driver is installed in the ADSL modem 106 rather than the user computer 102.

On initial setup, if the user's computer 102 is configured for DCHP and the browser is configured to use the existing network configuration, all the user 100 has to do to is to connect the ADSL modem 106 to the Ethernet NIC, reboot the computer 102, and request a web page. Since the device is not configured, the communication device 106 cannot connect to the Internet. The embedded UI modem 106, redirects the request to a local web server residing onboard the embedded UI modem 106. Returned is a setup page with the host URL (hURL) 128 rather than the requested web page. As shown, the user 100 enters an ISP assigned username in the username text field 128A and password into the password text field 128B. The user clicks the connect button 128C and the result is the authentication of a PPP session over Ethernet.

At this point, the user 100 has established connectivity to the ISP 124. However, since a web browser may cache DNS information, the user is instructed to close (quit) the browser program and re-open the browser to access the Internet. As a result, the user 100 now can request content from the Internet provided by Internet sites/servers 122 such as those provided at www.ebay.com 122A, www.yahoo.com 122B, www.cnn.com 122C, or other content providers.

After the initial configuration, the embedded UI modem 106 attempts to transmit requests to access Internet content onward to the access network 110, which in turn, connects with the ISP point of presence 124. If the embedded UI modem 106 cannot initiate a successful network session, the modem redirects the request to the local web server within the embedded UI modem 106. Returned is a diagnostic page with the host URL (hURL) 130 rather than the requested web page. The user 100 can run a diagnostic test by clicking the run test button 130A. The modem will test each leg of the connection and provide the diagnostic web page 130 with hyperlinks to various help pages for troubleshooting instructions. If connectivity is established at this point, the user 100 has established connectivity to the ISP 124. However, since a web browser may cache DNS information, the user is instructed to close (quit) the browser program and re-open the browser to access the Internet 120.

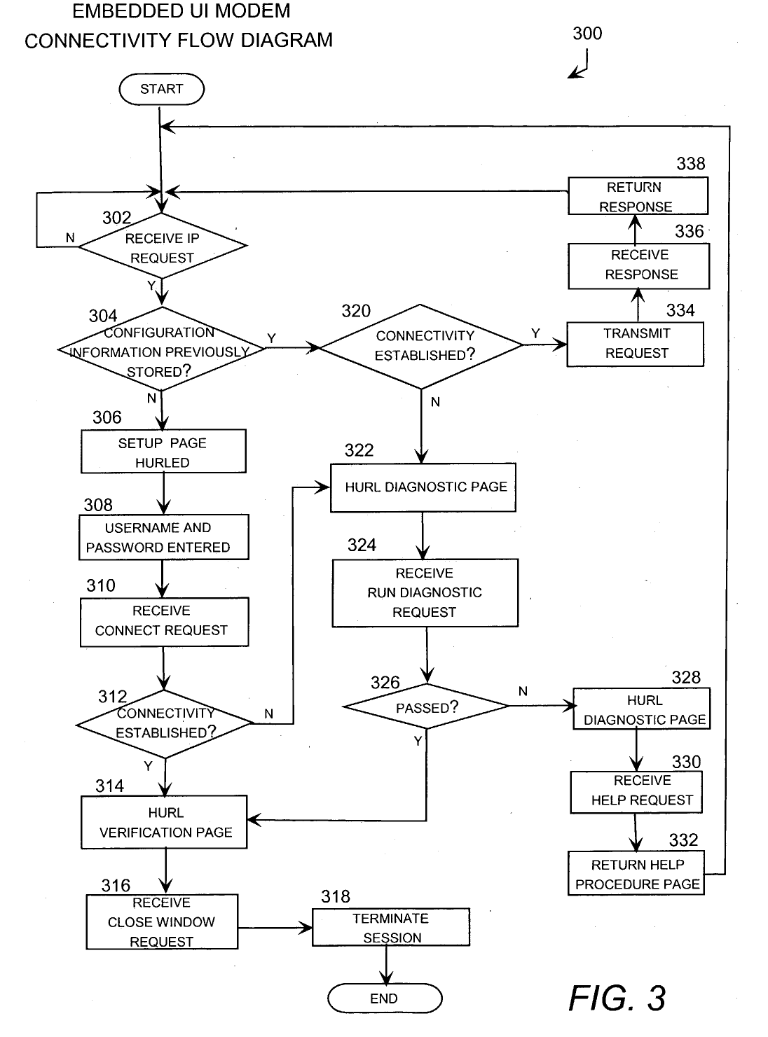

FIG. 3 is a flow chart of an embedded UI modem connectivity sequence 300 of an exemplary embodiment of the present invention. The connectivity sequence 300 begins with the communication device (e.g. a modem as illustrated) connected to an Ethernet NIC awaiting an IP session request.

In step 302, a processor in the modem determines if an IP session request has been received. If no request has been received, the N branch of step 302 is followed and step 302 is repeated until a request has been determined. Upon receipt of an IP session request, the Y branch of step 302 is followed to step 304.

In step 304, the processor determines if the modem has been configured. If the modem has not been configured, the N branch is followed to step 306. In step 306, the request is redirected to a local web server within the modem. A setup page with the host URL (host IP address) is returned to the requesting computer. As a result, the user computer establishes a communication session with the local server rather than the requested web sever.

Step 306 is followed by step 308, in which the username and password fields are entered by the user. The username and password is provided by the subscriber's ISP for authorization to access the Internet. This information is stored locally on the modem as shown in reference to FIG. 9.

Step 308 is followed by step 310, in which the onboard processor receives a request to connect to the Internet. Step 310 is followed by step 312, in which connectivity status is determined. If connectivity is not established, the N branch of step 312 is followed to step 322, in which a diagnostic page associated with the host IP address is returned to the requesting computer. This page contains links to help pages providing troubleshooting instructions for the user to attempt to correct the failure. Once connectivity is established, the Y branch of step 312 is followed to step 314.

In step 314, a verification page is returned confirming Internet access and requesting the user to close and reopen the browser. Step 314 is followed by step 316 in which the close window request is received. Step 316 is followed by step 318, in which the local server terminates the session. After step 318, the configuration process is complete. It will be apparent to those skilled in the art that once them modem is configured, communications with the Internet can be established.

If the modem has been configured, the Y branch is followed to step 320, in which the connectivity status is determined. Connectivity status can be determined by failure of any test of any segment along the network for Internet access. Preferably, Internet connectivity is determined by pinging of a lookup response address provided by the DNS server assigned in the PPPoE session, as DNS resolution is consistently one the first steps to any new Internet request. However, failure can be determined by failing to receive a resolution from the DNS server or failure of any process required to achieve Internet access, such as ADSL synchronization with the DSLAM, locating a PPPoE server, establishing a PPPoE session, etc.

If connectivity is not established, the N branch of step 322 is followed to step 322. In step 322, the request is redirected and a diagnostic page is returned with the modem's IP address. The diagnostic page identifies the failure to the DSL service. The diagnostic page is returned to the user to request that the user rerun the test to ensure the failure is consistent. Step 322, is followed by step 324 in which a request to run the diagnostic is received. Step 324 is followed by step 326. In step 326, the status of each segment of the DSL service is determined.

If Internet connectivity is determined to be successful, the Y branch of step 326 is followed to step 314, in which a verification page is returned to the user. If Internet connectivity is determined not to be successful, the N branch of step 326 is followed to step 328. In step 328, the diagnostic page is returned to the user identifying the failure mode.

Step 328 is followed by step 330, in which a help request is received. Step 330 is followed by step 332 which returns the appropriate troubleshooting instructions for the user to follow. Step 322 is followed by step 302, in which the processor awaits another HTTP request.

If the modem was configured and connectivity is established, the Y branch of step 320 is followed to step 334. In step 334, the modem encapsulates the IP packets in PPPoE frames to transmit to the ISP. Step 334 is followed by step 336 in which the modem receives the response packets from the requested Internet server. Step 336 is followed by step 338, in which the modem encapsulates the IP packets in Ethernet frames to transmit to the user computer. Step 338 is followed by step 302, in which the processor awaits another IP request.

As shown by the connectivity flow diagram 300, a determination is made each time an IP request is received whether to hURL a response from the local server or to send the request to the access network for further processing.

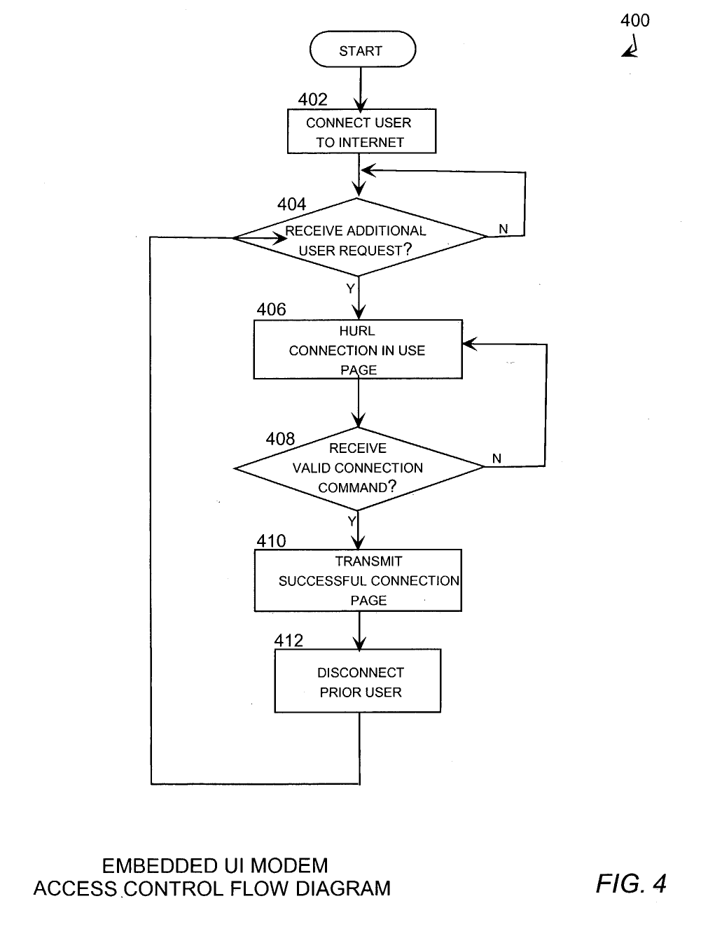

FIG. 4 is a flow chart of an embedded UI modem user control sequence 400 of a preferred embodiment of the present invention. It may be desirable to control the number of users allowed to access the network at any given time (e.g. to increase the revenue stream on an ISP). The preferred embodiment of a modem with an embedded user interface only allows one user to access the network pursuant to a standard license agreement.

The access control sequence 400 begins with the communication device (modem) awaiting an HTTP request from a user. In step 402, a processor in the modem connects a user as described in reference to FIG. 3. Step 403 is followed by step 404, in which the processor awaits a request for Internet access from a second user. If another user does not request access, the N is followed and awaits such a request.

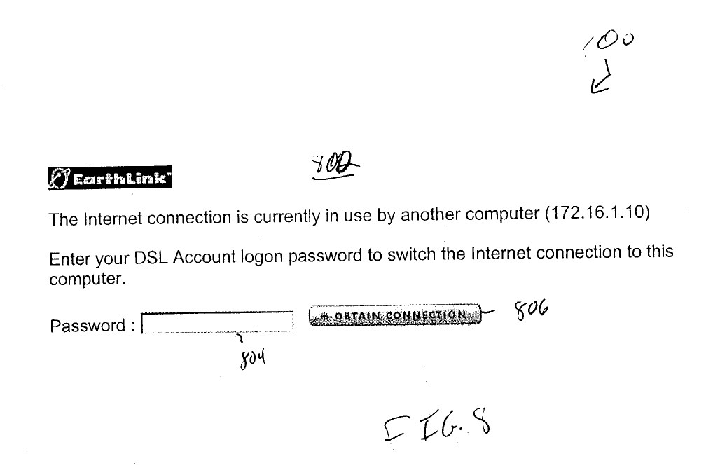

If another user does request access, the Y step of 404 is followed to step 406. In step 406, the request is redirected to a local web server onboard the modem. A connection-in-use page, described in reference to FIG. 8, is returned to the second user instead of the requested web page. The connection-in-use web page is returned with the modem's IP address and establishes a session with the second user's computer. The connection-in-use page requests the user to provide, in the appropriate text fields, the password provided by their ISP to access the Internet.

Step 406 is followed by step 408. In step 408, the processor determines if a valid password has been returned. If the connection request is not valid, the N branch of step 408 is followed to step 406, in which another connection-in-use page is hurled to the second user. If the password is valid, the Y branch of step 408 is followed to step 410, in which a successful connection page is returned. At this point, the second computer has established connectivity to the ISP. However, since a web browser may cache DNS information, the user is instructed to close (quit) the browser program and re-open the browser to access the Internet. The processor then engages step 412, which terminates the first computer connection thereby completing the process. Step 412 is followed by step 404, in which the processor awaits a request for Internet access by a different user.

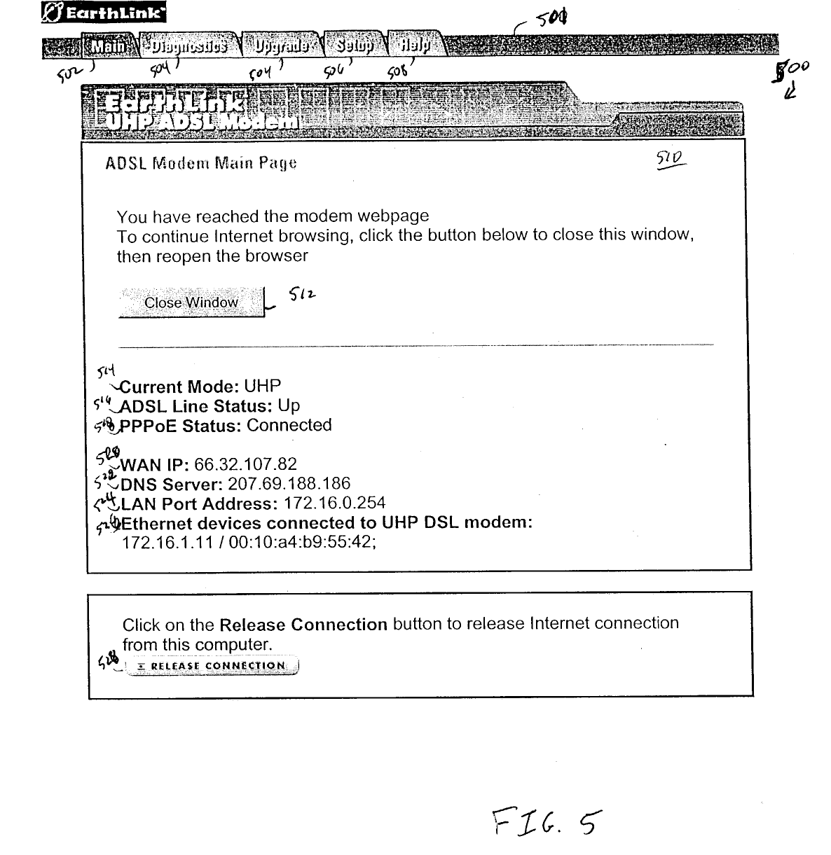

FIG. 5 illustrates an exemplary screen display 500 of the ADSL modem main page. The display 500 acknowledges that a user has reached the modem webpage. This web page 500 is also sent as the validation of a successful configuration and connection.

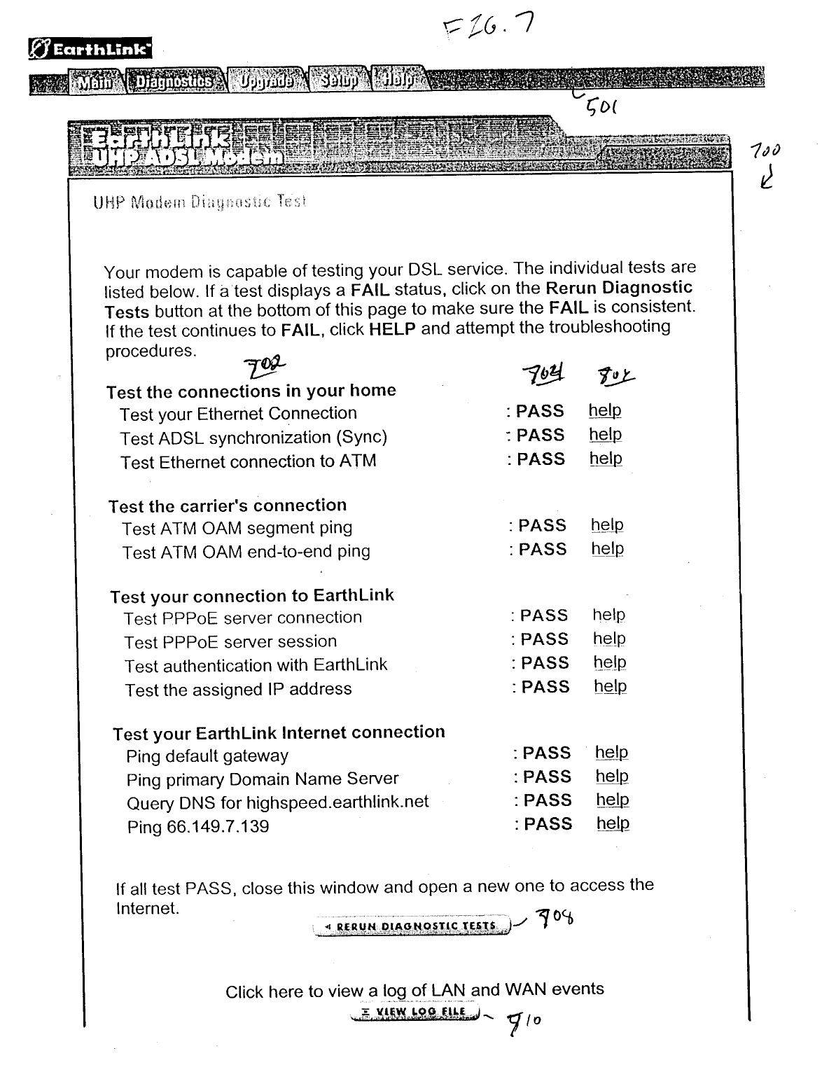

The main page has header links 501 that include a link 502 to request the main page, a diagnostic link 504 to request the diagnostic page (described in reference to FIG. 7), an upgrade link 504 to return the upgrade page, a setup link 506 to return the setup page, and a help link 508.

The main page 500 has a text area 510 that informs the user that they have reached the modem webpage and has instructions on how to proceed with Internet browsing. The text area 510 also include a close window button 512 to close the current web session. Also, included in the page 500 is a Current Mode status 514, an ADSL Line Status 516, and a PPPoE Status 518. Also provided is the WAN IP address 520 assigned by the DCHP server during an initial setup of that PPPoE session and the DNS Server IP address assigned during the initial setup of that PPPoE session. In addition, the current LAN Port Address 524 is displayed and Ethernet devices connected to DSL modem 526 with the addresses provided by the local DCHP server. Finally, a release connection button 528 is provided to release the Internet connection from that computer.

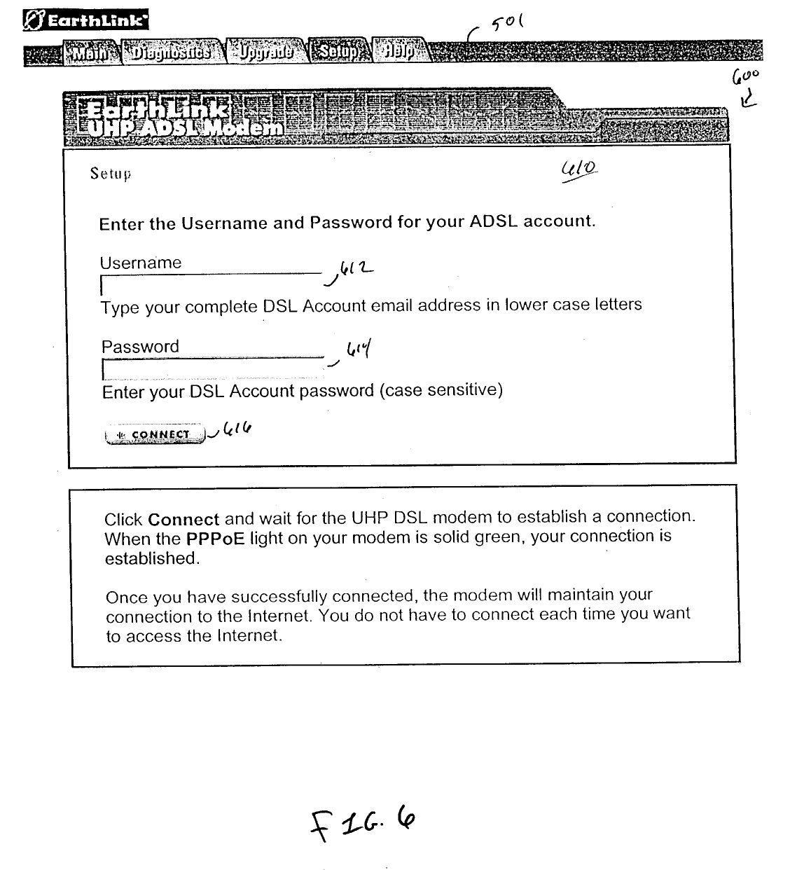

FIG. 6 illustrates an exemplary screen display 600 of the Setup page. The Setup page 600 includes fields for input by the user to configure the modem. This web page 600 also includes the header links 501 to navigate through the web site. The web page provides a main area 610 that requests the user to enter their username in the username text field 612 and their password into the password text field 614. A connect button 616 is activated to request the modem to attempt to establish an Internet connection. If establishing a connection fails, the Modem Diagnostic Test page described in reference to FIG. 7 is returned.

FIG. 7 illustrates an exemplary screen display 700 of the Modem Diagnostic Test page. This web page 700 also includes the header links 501 to navigate through the web site. The Diagnostic page 700 displays the results of testing the DSL service. The various tests performed during the diagnostic testing are listed in the segment test column 702. The results of each segment test is displayed in the status column 704 by displaying an indication of PASS or FAIL state. Each segment test has an associated help button or a fail state link as provided in column 706. Activating a fail state link will request the associated troubleshooting page that provides detailed troubleshooting instructions. Additionally, the Diagnostic page 700 includes a Rerun Diagnostic Tests 708 button which requests the modem to rerun the diagnostic tests and return the diagnostic page 700 indicating the results of the retest. Finally, the page 700 has a View Log File button 710 that return a page displaying a log of LAN and WAN events.

FIG. 8 illustrates an exemplary screen display 800 of a Connection-In-Use page. The page 800 informs the user that the Internet connection is in use by another computer. The page 800 has a text area with instructions for the user to enter their DSL account logon password to switch the Internet connection to their current computer. The page 800 has a text field 804 for the user to input the password. Additionally, the page has an Obtain Connection button 806 to request that the previous connection be terminated and the current computer be used for the Internet connection.

Turning now to FIG. 9, illustrated is an exemplary ADSL modem 106 in accordance with an embodiment of the present invention. Those skilled in the art will be familiar with each component of the exemplary ADSL modem 106. The modem 106 includes a Register Jack-45 (RJ-45) 910 for physically connecting the modem to a local area network (LAN). An Ethernet Physical Layer chip 908 performs the function of processing packets encapsulated in Ethernet frames for communications between a computer on the LAN and the modem 106. The modem 106 also includes a Register Jack-11 (RJ-11) 912 for physically connecting the modem 106 to a broadband access network. An ADSL Physical Layer chip 912 performs the function of processing packets encapsulated in Point to Point Protocol over Ethernet PPPoE frames for communications between the modem over the access network to a PPP termination device. In addition, a power supply connector 920 is provided to physically connect the power supply circuitry 918 with an external power supply.

A processor 902 determines if the modem is not configured, not connected, or the connection is already in use. The application programs that test the connectivity and analyze the packets are stored in the associated flash memory 906. A listing of the tests for each segment of the DSL service is provided in reference to FIG. 7. The modem 106 has LED lights 916 to display the connectivity status. If the modem is not configured, not connected, or the connection is already in use, the modem hURLs a web page stored locally in the flash memory 906 or generated in the processor 902. Otherwise, the request is delivered to the ADSL Physical Layer chip 912 for processing and delivery to the broad access network. In addition, the flash memory 906 stores the user configuration information. The web server application is stored in the static memory 906 or may be generated by an application program running on the processor 902. The static memory 906 also stores other application programs to control the functions associated with a standard ADSL modem which are not anticipated to change frequently such as the input/output control functions, DHCP and NAT applications.

In view of the foregoing, it will be appreciated that the invention provides for an embedded user interface in a communication device to facilitate configuring, troubleshooting, and controlling access to a wide area network. It should be understood that the foregoing relates only to the exemplary embodiments of the present invention, and that numerous changes may be made therein without departing from the spirit and scope of the invention as defined by the following claims. Accordingly, it is the claims set forth below, and not merely the foregoing illustration, which are intended to define the exclusive rights of the invention.

1. A system for providing a user interface for a hardware communication device comprising:
the hardware communication device including a processor for providing an embedded user interface, the hardware device operative for providing data communications between a user computer and a communication network;
the processor associated with the hardware communication device, the processor operative, prior to configuration of the hardware communication device, to intercept n network request provided by a user's computer and return an embedded HTML document associated with a host device IP address wherein the embedded HTML document comprises the embedded user interface;
the embedded user interface being operative for prompting an input of user configuration information; and
the processor operative to store the user configuration information in memory associated with the processor.

2. The system of claim 1 further comprising:
the processor operative to determine if access to a wide area network is currently available; and
the embedded user interface being operative for displaying troubling shooting information directed to establishing access.

3. The system of claim 1 further comprising:
the processor operative to determine if an additional computer is requesting access to a wide area network;
the embedded user interface being operative for authenticating access privileges to the wide area network; and
if the access privileges are authenticated, controlling the wide area access of any computer.

4. A system for providing a user interface for a hardware communication device comprising:
the hardware communication device including an embedded user interface, the hardware device operative for providing data communications between a user computer and a communication network;
a processor associated with the hardware communication device, the processor operative to determine if access to a wide area network is currently available;
if access is not available; the processor is operative to intercept a network request provided by a user's computer and return an embedded HTML document associated with a hardware communication device IP address wherein the embedded HTML document comprises the embedded user interface;
the embedded user interface being operative for displaying troubling shooting information directed to establishing access.

5. The system of claim 4 further comprising:
the processor operative to determine if the communication device has been configured;
the embedded user interface being operative for prompting an input of user configuration information; and
the processor operative to store the user configuration information in memory associated with the processor.

6. The system of claim 4 further comprising:
the processor operative to determine if an additional computer is requesting access to a wide area network;
the embedded user interface being operative for authenticating access privileges to the wide area network; and
if the access privileges are authenticated, controlling the wide area access of any computer.

7. A system for providing a user interface for a hardware communication device comprising:
the hardware communication device including an embedded user interface, the hardware device operative for providing data communications between a user computer and a communication network;
a processor associated with the hardware communication device, the processor operative to determine if an additional computer is requesting access to a wide area network;
if an additional computer is requesting access; the processor is operative to intercept a netowrk request provided by the additional computer and return an embedded HTML document associated with a hardware communication device IP address wherein the embedded HTML document comprises the embedded user interface;
the embedded user interface being operative for authenticating access privileges to the wide area network;
if the access privileges are authenticated, controlling the wide area access of any computer.

8. The system of claim 7 further comprising:
the processor operative to determine if access to a wide area network is currently available; and
the embedded user interface being operative for displaying troubling shooting information directed to establishing access.

9. The system of claim 7 further comprising:
the processor operative to determine if the communication device has been configured;
the embedded user interface being operative for prompting an input of user configuration information; and
the processor operative to store the user configuration information in memory associated with the processor.

10. A method for providing a user interface for a hardware communication device comprising the steps of:
generating an embedded user interface;
prior to configuration of the hardware communication device, intercepting a network request provided by a user's computer and returning an embedded HTML document associated with a host device IP address wherein the embedded HTML document comprises the embedded user interface;
prompting an input of user configuration information; and
storing the user configuration information in memory associated with the processor.

11. The method of claim 10 further comprising the steps of:
determining if access to a wide area network is currently available; and
displaying troubling shooting information directed to establishing access.

12. The system of claim 10 further comprising the steps of:
determining if an additional computer is requesting access to a wide area network;
authenticating access privileges to the wide area network; and
if the access privileges are authenticated, controlling the wide area access of any computer.

13. A method for providing a user interface for a hardware communication device comprising the steps of:
generating an embedded user interface;
determining if access to a wide area network is currently available;
if access is not available; intercepting a network request provided by a user's computer and returning an embedded HTML document associated with a hardware communication device IP address wherein the embedded HTML document comprises the embedded user interface;
displaying troubling shooting information directed to establishing access.

14. The method of claim 13 further comprising the steps of:
determining if the communication device has been configured;
prompting an input of user configuration information; and
storing the user configuration information in memory associated with the processor.

15. The system of claim 13 further comprising the steps of:
determining if an additional computer is requesting access to a wide area network;
authenticating access privileges to the wide area network; and
if the access privileges are authenticated, controlling the wide area access of any computer.

16. A method for providing a user interface for a hardware communication device comprising the steps of:
providing an embedded user interface;
determining if an additional computer is requesting access to a wide area network;
if an additional computer is requesting access, intercepting a network request provided by the additional computer and returning an embedded HTML document associated with a hardware communication device IP address wherein the embedded HTML document comprises the embedded user interface;
authenticating access privileges to the wide area network;
if the access privileges are authenticated, controlling the wide area access of any computer.

17. The system of claim 16 further comprising the steps of:
determining if access to a wide area network is currently available; and
displaying troubling shooting information directed to establishing access.

18. The system of claim 17 further comprising steps of:
determining if the communication device has been configured;
prompting an input of user configuration information; and
storing the user configuration information in memory associated with the processor.

19. A method for communication management comprising the steps of:
receiving a network request to access a wide area network wherein the wide area network is not available to receive the request; and
returning a response generated locally that associates the local host address instead of providing the requested content associated with the requested address.

20. The method of claim 19 wherein the step of returning a response comprises:
providing an embedded user interface, wherein the embedded user interface requests configuration information; and
transmitting the embedded user interface to a computer that originated the request.

21. The method of claim 19 wherein the step of returning a response comprises:
testing segments of a the wide area network;
providing an embedded user interface, wherein the embedded user interface provides troubleshooting information.
transmitting the embedded user interface to a computer that originated the request.
